(19) United States
(12) Patent Application Publication
(10) Pub. No.: US 2012/0267531 A1
(43) Pub. Date: Oct. 25, 2012

(54) ELECTRONIC DEVICE FOR BASELINING THE CURRENT EMITTED BY ELECTROMAGNETIC RADIATION DETECTORS

(75) Inventor: Gilles Chammings, Grenoble (FR)

(73) Assignee: COMMISSARIAT A L'ENERGIE ATOMIQUE ET AUX ENE ALT, Paris (FR)

(21) Appl. No.: 13/321,346

(22) PCT Filed: May 27, 2010
(86) PCT No.: PCT/EP2010/057314

§ 371 Date: Jun. 26, 2012

(30) Foreign Application Priority Data
May 27, 2009 (FR) 09 53503

(51) Int. Cl. G01J 1/42; G01J 5/20; G01J 5/10

(52) U.S. Cl. 250/338.4; 250/336.1; 250/338.1; 250/349; 250/394; 250/370.01

(57) ABSTRACT

A microelectronic device for electromagnetic radiation measurement including a bolometer and an integrator including an integration capacitor, to output, during an integration time, a first signal with variable amplitude and frequency according to the current emitted by the detector, in a form of a series of pulses, and a controller controlling the first signal, to deliver a second signal. The controller includes: a counting device to count each pulse of the first signal detected during an integration time and to indicate an end of counting when a predetermined number N of pulses is reached, and when the end-of-integration time is reached and a predetermined number N of pulses has been counted or deducted by the counter, to emit a second amplitude signal, depending on or equal to the amplitude of the first signal.

### TECHNICAL FIELD AND BACKGROUND OF THE INVENTION

The invention relates to the field of electromagnetic radiation sensors, and in particular that of bolometer sensors, i.e. thermal photodetectors used to measure a quantity of absorbed energy flow, owing to a resistance variation caused by heating a plate or a detection layer, and able to measure the power of an electromagnetic radiation in fields such as hyperfrequencies or infrared radiation.

The invention in particular relates to bolometer sensors arranged in a matrix of X×Y pixels, X being a number of columns (or vertical rows) of pixels and Y a number of lines (or horizontal rows) of pixels.

In infrared imaging, an imager is used comprising a matrix of pixels to sense the infrared flow, with a bolometer per pixel in order to produce an infrared image of a scene, i.e. a surface covered when an image is recorded and the template of which results in observation conditions and properties of the sensor used.

A bolometer is a resistive sensor whereof the resistance varies with the temperature and therefore the radiation flow coming from the scene.

To read the value of the resistance of the bolometer that corresponds to an infrared flow, it is for example possible to impose a voltage and measure a current.

However, a scene variation, even significant, causes a relatively weak current variation, the signal emitted by the bolometers having a significant direct component.

A scene temperature variation, for example in the vicinity of 50 K, can in certain cases cause a current variation, for example in the vicinity of 1%.

This direct component is detrimental to the signal to noise ratio and it is necessary to perform an operation that consists of eliminating or reducing said direct component.

A microelectronic device sensing electromagnetic radiation according to the prior art, in which such an operation is performed, is given in FIG. 1.

In this device, one removes, from the current Idet coming from a detector 2, a current Im with a predetermined fixed value, for example with a value close to the average value of the current of the sensor.

This fixed-value current comes from a fixed current source, which can for example be formed using a bolometer referenced 1 that is insensitive or made insensitive.

The reference bolometers can for example be provided at the foot of the column or the head of the column of a pixel matrix.

One thus seeks to obtain as small a current as possible to be integrated and that corresponds to the variations of the resistance of the sensitive bolometer under the effect of the electromagnetic radiation flow of the scene.

The current I coming from the difference between the current coming from the sensitive bolometer

Idet and the current Im coming from the reference bolometer is converted into voltage owing to an integrating circuit 3, which can be formed by an amplifier 4 and an integration capacitor 5 with capacity Cint.

The gain of this conversion depends on the integration time Tint and the value of the integration capacity V=I×Tint/Cint). Only a difference I=Idet−Im is processed. This difference is typically in the vicinity of 100 times smaller than the current Idet.

The output of the converter is connected to means forming a reading circuit 8 of the bolometer.

The implantation of sensors made insensitive poses bulk problems. Furthermore, the lack of uniformity in their characteristics can pose problems.

In a matrix device, several reference bolometers made insensitive can be used.

Depending on how they have been implemented, the current Im can be different from one reference bolometer to the next.

The problem arises of finding a new detection device, which does not have the aforementioned drawbacks.

### BRIEF DESCRIPTION OF THE INVENTION

The invention first relates to a microelectronic device for electromagnetic radiation measurement including:
at least one electromagnetic radiation detector, such as a bolometer, provided to deliver a current based on the intensity of the detected radiation,
an integrating means including a means forming an integration capacitor, intended for outputting, during a particular duration called “integration time” between a beginning-of-integration moment and an end-of-integration moment, a first signal with variable amplitude and frequency according to said current emitted by the detector, in the form of a series of pulses,
a means for controlling said first signal, intended for emitting a second signal, the control means comprising a counting means intended for counting or deducting each pulse of said first signal detected during the integration time and for indicating the end of counting when a predetermined number N of pulses is reached, the control means being implemented, when the end-of-integration time is reached and a predetermined number N of pulses has been counted or deducted by said counting means, for emitting a second amplitude signal, depending on or equal to the amplitude of the first signal.

In such a device, one does away with the use of a reference sensor such as a bolometer made insensitive to eliminate a useless part of the signal emitted by the sensitive detector. Significant space savings are thus obtained. Sampling means, provided to store the second signal when the predetermined integration time has elapsed, can also be provided.

According to one possible embodiment, the control means can also comprise: means for detecting said pulses from the first signal.

The device can be adapted for an operating case in which the detector is under-lit. Thus, the control means can also be implemented, when the end-of-integration time is reached and a number smaller than N pulses has been counted or deducted by said counting means, for delivering a second signal with an amplitude equal to a first threshold potential.

The device can be adapted to an operating case in which the detector is over-lit.

The control means can also be implemented, when the end-of-integration time is reached and the number N of pulses has been counted or deducted by said counting means, for delivering a second signal with an equal amplitude, in particular at a saturation potential reached by the first signal.

The control means can also include: switching means implemented, when an end-of-counting is indicated by said counting means, for switching between a first threshold potential Vnoir, and the output of said integrating means delivering the first signal S1.

The control means can also include reinitialization means arranged, during the integration time, following each pulse detected in the first signal and as long as the number N of detected pulses is not reached, for applying a reinitialization signal, to at least one terminal of said integration capacitor so as to vary the first signal in a manner opposite said detected pulse.

The reinitialization means can be arranged to stop the application of the retroaction signal when the number N of detected pulses is reached.

The reinitialization means can comprise a means forming at least one switch, said switch being controlled by at least one signal indicating the beginning of counting provided for reinitializing counting done by the counting means, and at least one signal indicating the end of counting generated by the counting means when the predetermined number N of pulses is reached.

The reinitialization means can comprise means forming at least one first pair of switches, and at least one second pair of switches, the first pair of switches and the second pair of switches being controlled by the counting means.

The first pair of switches can be provided to connect a first terminal of the capacitor alternatively to the output and a inverting input of an amplifier, the second pair of switches being provided to connect a second terminal of the capacitor, alternatively to the inverting input and the output of the amplifier.

Said detector can belong to a detector matrix.

According to one particular embodiment, several of said cells can be equipped with a microelectronic device as previously defined, integrated thereto.

According to this particular embodiment, said integration capacitor can be formed by a transistor.

### BRIEF DESCRIPTION OF THE DRAWINGS

The present invention will be better understood upon reading the description of embodiments provided solely for information and non-limitingly in reference to the appended drawings, in which:

FIG. 1 illustrates one example of a bolometer sensor according to the prior art,

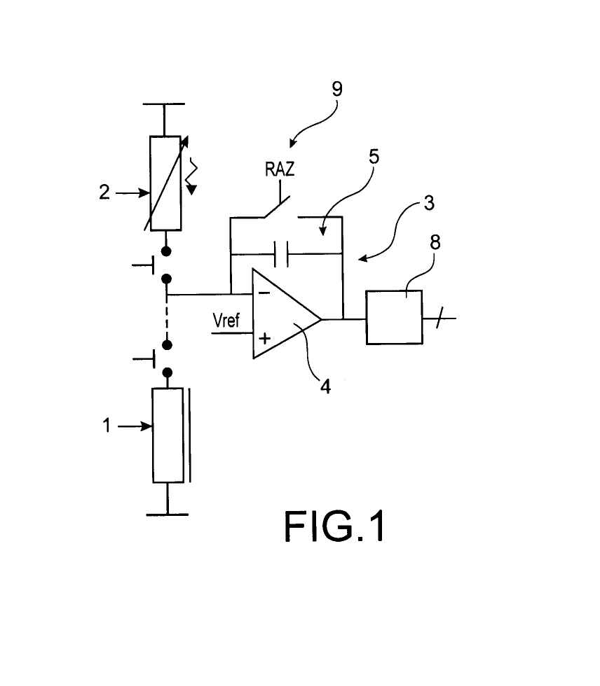

FIG. 2 illustrates a first embodiment of a device according to the invention belonging to a bolometer matrix sensor,

FIGS. 3A to 3C show signals implemented within the first embodiment described in connection with FIG. 2,

FIG. 4 illustrates a second embodiment of a device according to the invention belonging to a bolometer matrix sensor,

FIGS. 5A to 5C show signals implemented within the second embodiment of the device described relative to FIG. 4,

FIG. 6 illustrates a third embodiment of the implementation of a device according to the invention belonging to a bolometer matrix sensor,

FIGS. 7A to 7C show signals implemented in a third embodiment of the device described relative to FIG. 6.

Identical, similar or equivalent parts of the different figures described below bear the same numerical references so as to facilitate the transition from one figure to the next.

The different parts shown in the figures are not necessarily shown using a uniform scale, to make the figures more legible.

The different possibilities (alternatives and embodiments) must be understood as not being mutually exclusive and can be combined with each other.

### DETAILED DESCRIPTION OF THE INVENTION

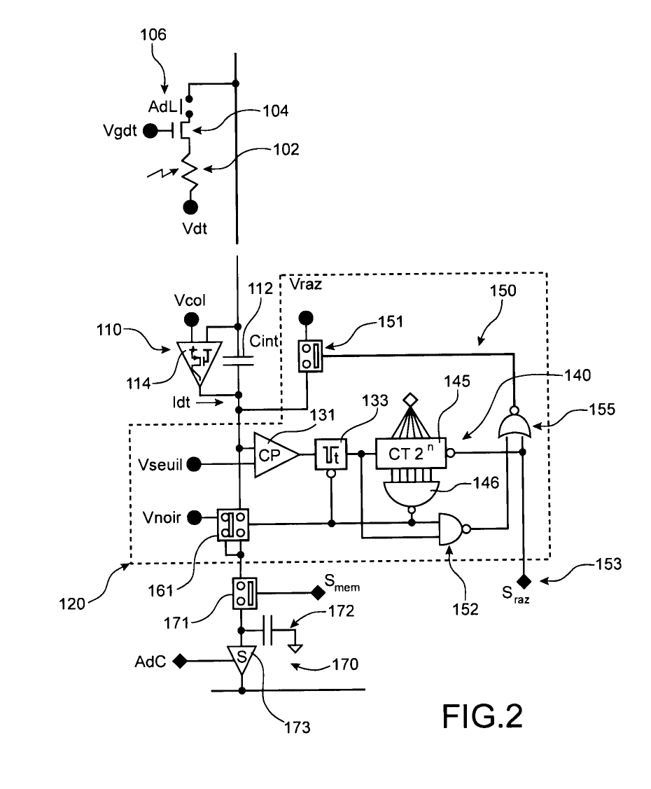

A first example of a microelectronic imaging device, in particular with bolometers, will now be given relative to FIG. 2 (only part of the imager, and in particular an elementary cell of the imager, being shown in FIG. 2).

This device is part of a matrix of X horizontal rows and Y vertical rows of elementary cells, also called “pixels.” The elementary cells are each provided with at least one sensor including an element detecting electromagnetic radiation of the bolometer type.

An elementary cell can include at least one bolometer detector in the form of a thermistor 102, i.e. a resistance varying with the temperature. The output of the thermistor can be associated with a transistor 104 whereof the gate is polarized at a potential Vgdt, in order to deliver a detection current.

Switching means 106, controlled by a signal AdL for addressing lines, i.e. horizontal rows of the matrix, are in this embodiment provided at the output of the detector so that the latter delivers the detected current to a column of the matrix, when the horizontal row of the matrix to which that detector belongs is selected. The switching means 106 can for example assume the form of a transistor, making it possible to connect the bolometer to a reading circuit or reading means during a capture cycle.

A polarization voltage applied to the terminals of the bolometer 102 is constant during that capture. Thus, when the temperature varies, and the scene changes, i.e. the radiation perceived by the sensor changes, the resistance of the bolometer 102 varies, which involves, given the constant voltage at the terminals of the bolometer 102, a variation of the current passing through it.

The current coming from the bolometer 102 is converted using integrating circuits 110, which output a signal called first signal S₁.

The integration means 110 can in this example comprise an amplifier 114. The amplifier 114 can be equipped with a non-inverting input set to a polarization potential Vcol, as well as an output and a inverting input connected to the terminals of means forming an integration capacitor 112, with capacity Cint.

The polarization potential Vcol can be provided and set according to the incident electromagnetic energy range to be detected. The potential Vcol can be chosen to be equal or close to another polarization potential Vseuil.

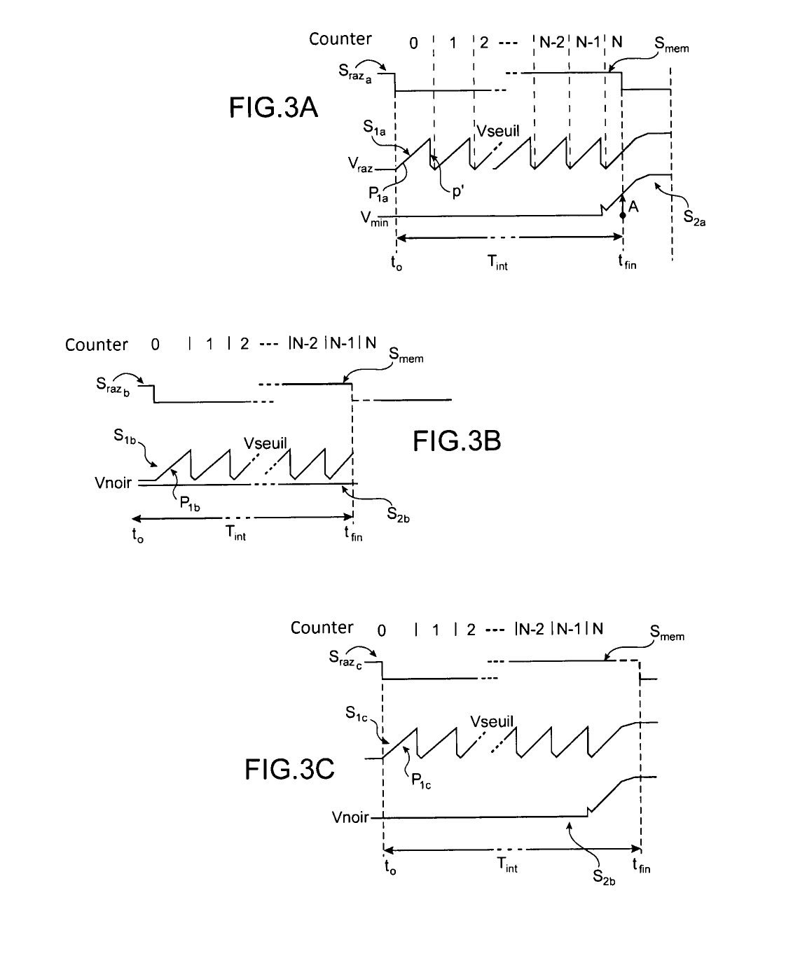

The detected current is integrated during a period called integration time Tint, comprised between a moment called “start of integration” t₀ and a moment called “end of integration” t_{fin} (Tint being set in the three operating examples of the device provided relative to FIGS. 3A-3C, the scales not necessarily being identical between these three figures).

The beginning of the integration can be determined by and/or consecutive to a change of state of a so-called “reinitialization” signal Sraz, while the end of the integration can be determined by and/or consecutive to a change of state of a so-called “storage” signal Smem.

The first signal S1 (shown in the time charts of FIGS. 3A, 3B, 3C, by the curves of signals S1a, S1b, S1c, respectively), result of the integration of the current emitted by the detector, is in the form of a series of pulses (P1a, P1b, P1c, respectively) whereof the duration and frequency depend in particular on the capacity Cint chosen for the integration capacitor 112, as well as the intensity of the current emitted by the bolometer 102, which itself depends on the incident electromagnetic energy on the bolometer 102.

In FIGS. 3A, 3B, 3C, the first signal S1 is shown for different values of currents emitted by the detector 102, and therefore for different incident electromagnetic energies on the bolometer 102.

A first operating case is given in FIG. 3A, while in FIGS. 3B and 3C, the first signal S1 is shown respectively for a second case, with under-polarization or under-lighting of the detector 102, and for a third case, over-polarization or over-lighting of the detector 102.

The number of pulses of the first signal S₁ is intended to be counted, during the integration period Tint, which is the same in all three operating cases.

Control means 120 for the first signal S₁ are arranged at the output of the integration means 110, and are intended to deliver a second signal S₂, in which a part of useless information from the first signal has been eliminated.

The control means 120 are arranged to implement a detection of the pulses of the first signal S₁. To that end, the output of the integration means 110 can be applied to the inverting input of a comparing element 131, and is compared to a polarization potential Vₛₑᵤᵢₗ applied to the non-inverting input of the comparing element 131. The result of the comparison between the first signal and Vseuil is put in the form of a two-state signal. A monostable 133 at the output of the comparing element 131 can be provided in order to obtain a signal in the form of calibrated pulses.

A pulse detection is thus implemented in order to count or deduct said pulses. To that end, the two-state signal emitted by the monostable can be delivered in particular to counting means 140 belonging to the control means 120.

The counting means 140 can then be implemented to count or deduct each new detected pulse in the first signal S₁.

The counting mean 140 can also be implemented to emit an end-of-counting indicator signal, once a predetermined number N of pulses is reached and has been counted or deducted.

The number N of pulses that the counting means are intended to count or deduct can be provided according to an evaluation of an average value of the current emitted by the detectors of the matrix.

The counting means 140 can for example comprise at least one counter 145, for example a digital counter, which can be associated with means for indicating the end of counting, for example comprising a NAND logic gate 146, at the output of the counter 145.

The end-of-counting indicator signal can in particular be transmitted to a reinitialization means 150, for example via a logic gate such as a NAND gate 152 connected to the output of the NAND gate 146 and the monostable 133.

The reinitialization means 150 are in particular provided, following a variation of the first signal S1 in the form of a pulse (pulse P1a of the first signal S1a in FIG. 3A), for applying a retroaction signal to the capacitor 112 so as to vary the first signal S₁, in a manner opposite said variation (part P′ of the first signal S1a in FIG. 3A).

In this embodiment, following a pulse causing the first signal S₁ to increase, a retroaction signal is applied to the capacitor 112 so as to decrease the first signal S₁.

The retroaction signal can be a retroaction potential Vraz, applied via switching means 151.

The reinitialization means 150 makes it possible, once a pulse has been detected and accounted for, for the output of the integrating circuit to be returned to potential Vraz. In this embodiment, this equates to a voltage drop of the first signal (portion P′ of signals S1a, S1b, S1c in FIGS. 3A, 3B, 3C).

The repeated application of a retroaction signal can be stopped once the counting means 140 have reached the predetermined number N of pulses.

The reinitialization means 150 can thus be provided, when they receive the end-of-counting indicator signal, for stopping the repeated openings and closings of the switching means 151. The switching means 151 can be controlled for example by a signal delivered by the means 155 forming a NO OR logic gate, one input of which is connected to the output of the counting means 140 and to the means 153 for applying a reset signal Sraz.

The retroaction making it possible to control the charges and discharges of the integration capacitor 112 is thus stopped once the number N of pulses is reached.

In FIGS. 3A and 3C, this translates to a curve Sla representative of the first signal which, once the number N is reached, continues to increase and is not returned to potential Vraz.

This blocking of the retroaction can be generated by a means for example comprising a NO OR logic gate 155, at the output of the counter 145 and the NAND gate 152.

The control means 120 are provided to deliver the second signal S₂. In this example, the second signal S2 is kept at a first threshold potential Vnoir as long as the counting done by the counting means 140 has not reached value N. In FIGS. 3A, 3B, 3C, this translates to curves S2a, S2b, S2c representative of the second signal S₂ that remain at level Vnoir, as long as the counting means have not reached value N. In other words, as long as the part of the signal one wishes to eliminate has not been reached, the control means 120 produce a second signal S2 equal to the first threshold potential Vnoir.

Switching means 161 are provided at the output of the control means 120 and are controlled by the end-of-counting signal delivered by the counting means 140. The end-of-counting signal delivered by the counting means 140 makes it possible to switch the switching means 161 so that when said means receive the end-of-counting signal, they connect the output of the control means 120 to the output of the integration means 110, and deliver a second signal that is equal to the output of the integrating circuit.

When the integration time Tint has elapsed, at moment tfin, the second signal S₂ is sampled, using a sampling means 170. The sampling means can comprise means forming a switch 171 controlled by a storage signal Smem, and which, when the signal Smem changes states, connects the output of the control means 120 to a storage capacitor 172. The sampling means 170 can also comprise a voltage follower 173, controlled by a column addressing signal AdC.

Two limit operating cases of the device are provided in connection with the time charts of FIGS. 3B and 3C.

One limit operating case is representative of under-lighting of the detector relative to the detection range of the bolometer or an under-polarization of the detector 102 is provided in FIG. 3B. In this case, when the integration time Tint has elapsed, the counting means 140 have not reached the counting value N, which keeps the output of the switching means 161 at potential Vnoir (signal S2b staying at Vnoir in FIG. 3C).

Thus, it is possible to detect any under-polarization of the detector 102 and adjust the polarization state of the detector 102 according to said detection.

A second case, of over-lighting relative to the detection range of the bolometer or over-polarization of the detector 102, is given in FIG. 3C. In this case, when the integration time Tint has elapsed, the counter 145 has reached the counting value N, which has blocked the retroaction. The switching means 151 of the reinitialization means is then open, and the integration capacitor 112 continues its charge and stays charged when its charge is finished. The output of the control means 120 is set at the output potential of the integration means 110, which reaches a saturation potential Vsat.

It is thus possible to detect any over-polarization of the detector 102 and adjust the polarization state of the detector 102 according to that detection.

One operating case of the detector, when it is normally lit and normally polarized, is given relative to FIG. 3A.

The beginning of the integration is triggered by a change of state of the reinitialization signal Sraz.

Then, a deduction or counting of the pulses from the first signal S₁ is done.

Each pulse produces a reinitialization. The repeated retroaction is stopped once the counting means 140 have reached the counting value N, which is done by keeping the switching means 151 of the reinitialization means 150 open.

When the counting means 140 have reached the counting value N, the switching means 161 switches and are connected to the output of the integration means 110. The integration capacitor 112 then continues its charge.

When the integration time has elapsed, the storage signal Smem changes state, so that a sampling at the output of the control means is done.

The amplitude A of the second signal S₂, which depends on that of the first signal S₁, is then stored for example via the capacitor 172.

The amplitude A of the second signal S₂ then follows the relationship below:

Idet*Tint=((N−1)*δV+A)*Cint, with Idet the current emitted by the detector and δV the amplitude of the detected pulses.

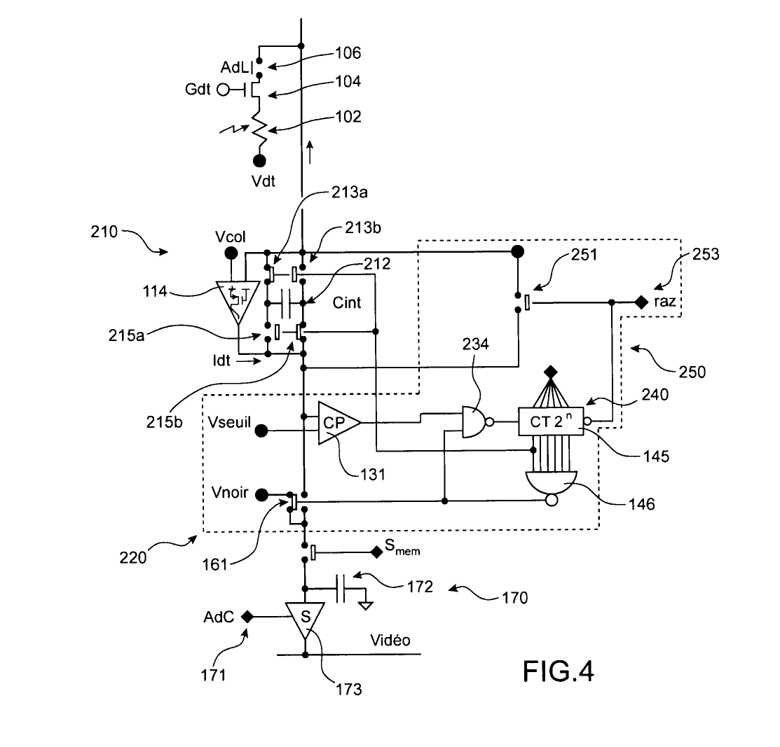

A second example of an imaging microelectronic device, in particular with bolometers, is shown in FIG. 4 (only part of the imager, and in particular an elementary cell of the imager, being shown in that figure).

The embodiment of the device differs from the previous one in particular by the integration means 210, which this time are equipped with an integration capacitor 212, the terminals of which can be connected alternatively to the inverting input or the output of an amplifier 114 via switches 213a, 213b, 215a, 215b.

The non-inverting input of the amplifier 114 can be set to a potential Vcol, comprised between a potential Vseuil and a potential Vnoir.

Control means 220 of the first signal S₁, delivered at the output of the integration means 210, are provided as in the previous example.

These control means 220 are provided for implementing a pulse detection in the first signal, for example using a comparing element 131 intended to compare the output of the integration means to a potential Vseuil.

In this example, the control means 220 comprise a NAND gate 234 at the output of the comparing element 131 which, associated with the NAND gate 146 situated at the output of the counter, makes it possible to lock the counting once the number N of pulses is reached. To that end, a NAND gate 234 can have an input connected to the output of the NAND gate 146 for indicating the end of counting, while its other input is connected to the output of the monostable 233.

The control means 220 differ from that described earlier relative to FIG. 2, also by the reinitialization means 250.

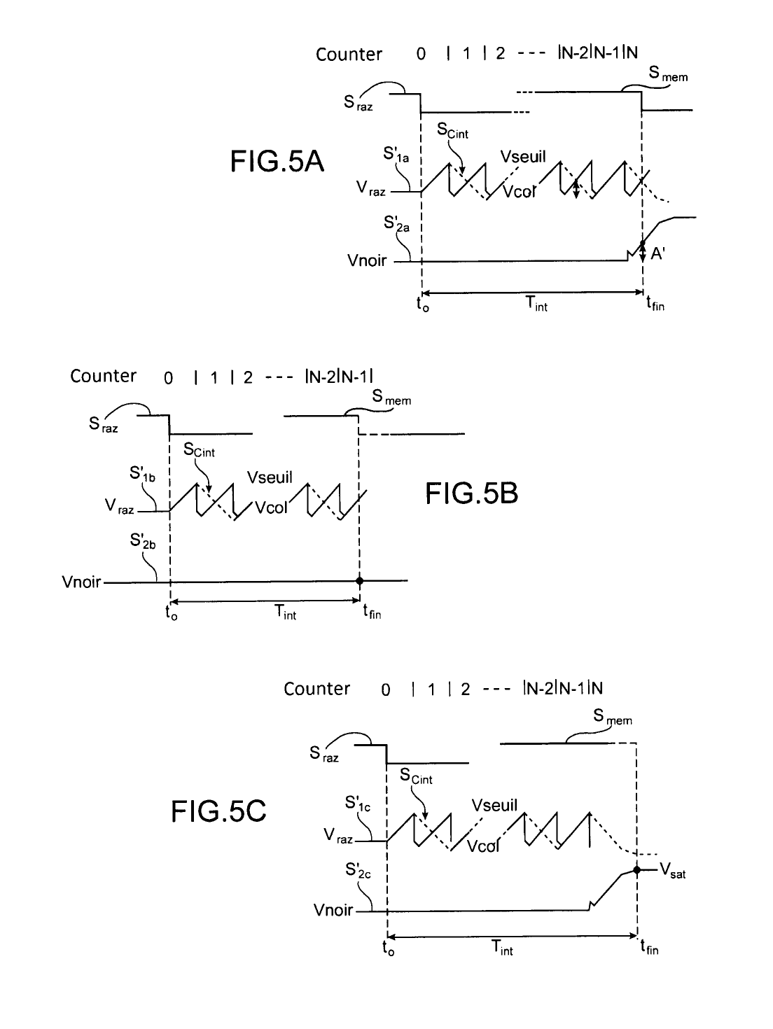

The reinitialization means 250 are provided, following a variation of the first signal S1 in the form of a pulse, varying the signal S1 (the first signal being shown by curves S′1a, S′1b, S′1c, in FIGS. 5A, 5B, 5C), for applying a retroaction signal to the capacitor 212 so as to vary the first signal S₁, in the manner opposite said variation.

The reinitialization means 250 also include a switch 251 and means 253 for applying a reset signal Sraz, the means 253 for example forming an external connection on which the reset signal is applied, such as a clock reset signal, making it possible to reset the counting means 240.

The switching means 251 can for example be controlled by a signal delivered by the output of the counting means 240 and the means 253 for applying a reset signal Sraz.

A signal Scint at the terminals of the integration capacitor is also shown in FIGS. 5A, 5B, 5C.

In this embodiment, following a pulse from the first signal S1 also increasing the signal Scint, a retroaction signal is applied to the capacitor 212 so as to decrease the signal Scint.

In this example, the signal at the terminals of the capacitor no longer has a sharp discontinuity as in the first embodiment, which contributes improvements, in particular in terms of noise generated during the integration.

The first pair of switches 213a, 213b and the second pair of switchers 215a, 215b are controlled by the counting means 240, for example by the low-weight bit of the counter 145, for example a digital counter.

Among the switches 213a, 213b, 215a, 215b, provided to connect the terminals of the integration capacitor 212 to the amplifier 114, a first pair of switches 213a, 215a is provided to connect a first terminal of the integration capacitor 212 alternatively, to the output or to the inverting input of the amplifier 114, while the second pair of switches 215a, 215b is provided to connect a second terminal of the integration capacitor 212, alternatively to the inverting input or the output of the amplifier 114. In other words, the first pair of switches 213a, 213b is provided to connect to the inverting input of the amplifier 114 alternatively, a first terminal or a second terminal of the integration capacitor 212, while the second pair of switches 215a, 215b is provided to connect the output of the amplifier 114 alternatively to the first terminal or the second terminal of the integration capacitor 212.

Upon each detected pulse, the open or closed state of the switches 213a, 213b, 215a, 215b is modified.

The repeated opening or closing control of the switches 213a, 213b, 215a, 215b can be stopped once the counting means have reached the predetermined number N of pulses.

The retroaction making it possible to control the charges and discharges of the integration capacitor 212 is thus stopped once the number N of pulses has been reached.

One limit case, representative of under-lighting of the detector relative to the detection range of the bolometer or an under-polarization of the detector, is given in FIG. 5B.

Another limit case, of over-lighting relative to the detection range of the bolometer or over-polarization of the detector, is given in FIG. 5C.

One operating case of the detector, when it is normally lit, is given in connection with FIG. 5A.

The beginning of the integration is triggered by a change of state of the reinitialization signal Sraz.

Then, a deduction or counting of the pulses of the first signal S₁ is done. Each pulse is followed by a retroaction equating to an opposite variation of the first signal.

The repeated retroaction is stopped once the counting means have reached the counting value N.

When the counting means 240 have reached the counting value N, the switching means 161 switches and are connected to the output of the integrating means 210. The integration capacitor 212 continues its charge.

When the integration time Tint has elapsed (Tint being fixed and therefore the same for the three operating examples of the device given relative to FIGS. 5A-5C, the scales not necessarily being identical between these three figures), at moment tfin, the second signal S₂ is sampled, using sampling means 170.

The amplitude A′ of the second signal S₂ follows the relationship below:

Idet*Tint=((N−1)*2δV′+A′)*Cint, with Idet the current emitted by the detector and δV the amplitude of the detected pulses.

As in the example previously described relative to FIG. 2, a detection of the state of the output of the stage 220 when the integration time Tint has elapsed, in order to detect any over-polarization or under-polarization of the detector 102 and adjust the polarization state of the detector 102, according to that detection, can be implemented.

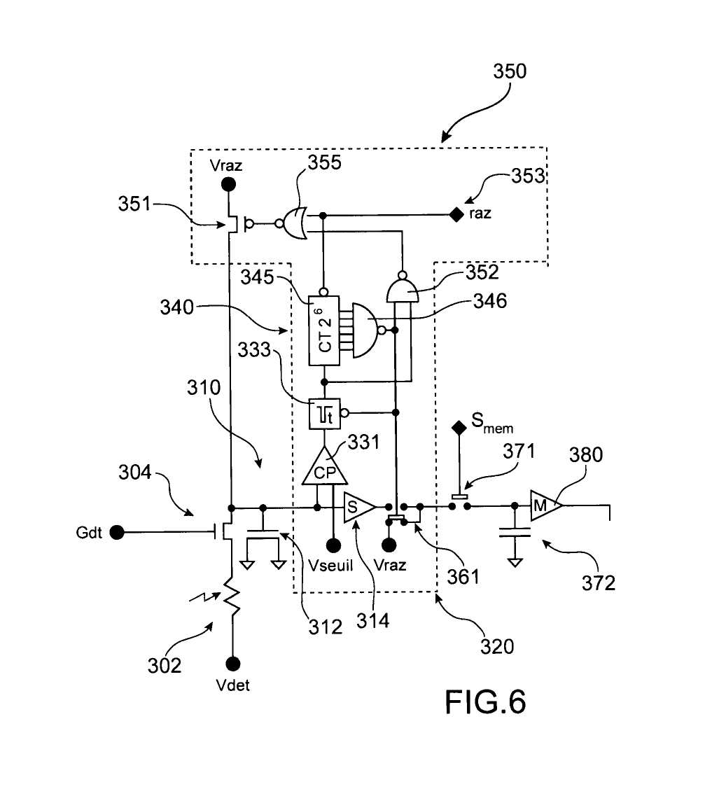

A third example of a microelectronic imaging device, in particular with bolometers, is shown in FIG. 6 (only part of the imager, and in particular an elementary cell of the imager, being shown in that figure).

In this example, the matrix is formed by elementary cells each including a bolometer 302, integration means 310 of the current emitted by the bolometer 302, as well as control means 320 that can be of the type of the control means 120 described earlier relative to FIG. 2.

In this example, the integration means 310 comprise an integration capacitor in the form of a transistor 312, for example of the MOS type, the gate of which is connected to an input of the control means 320, and the source and drain of which are put at the same polarization potential, for example the electrical ground.

This makes it possible to implement the integration capacitors and means in each pixel. The gate potential of the transistor 312 corresponds to the first signal S₁ controlled by the control means 320.

These control means 320 are equipped, as in the preceding examples, with means for detecting pulses from the first signal S₁ for example comprising a comparing element 331, means for producing calibrated pulses including a monostable 333.

The control means 320 also comprise counting means 340 for example equipped with at least one counter 345 associated with means forming one or more logic gates 346, 352.

The control means 320 also comprise reinitialization means 350 for example equipped with a switch 351 capable of applying a potential Vraz to the gate of the transistor 312, following a detection of a pulse from the first signal S1. The reinitialization done in this example can thus be similar to that implemented in the first example provided relative to FIG. 2.

As in the preceding examples, an integration can be triggered by a state change of a reinitialization signal Sraz applied to the reinitialization means 350 or produced by the reinitialization means 350.

When the integration time Tint has elapsed, the signal Smem for triggering sampling changes states.

If a number N of pulses has been detected, the switching means 361 at the output of the control means 320 delivers a second signal, the amplitude of which depends on that of the first signal S₁, and can in this example be equal to the first signal S1.

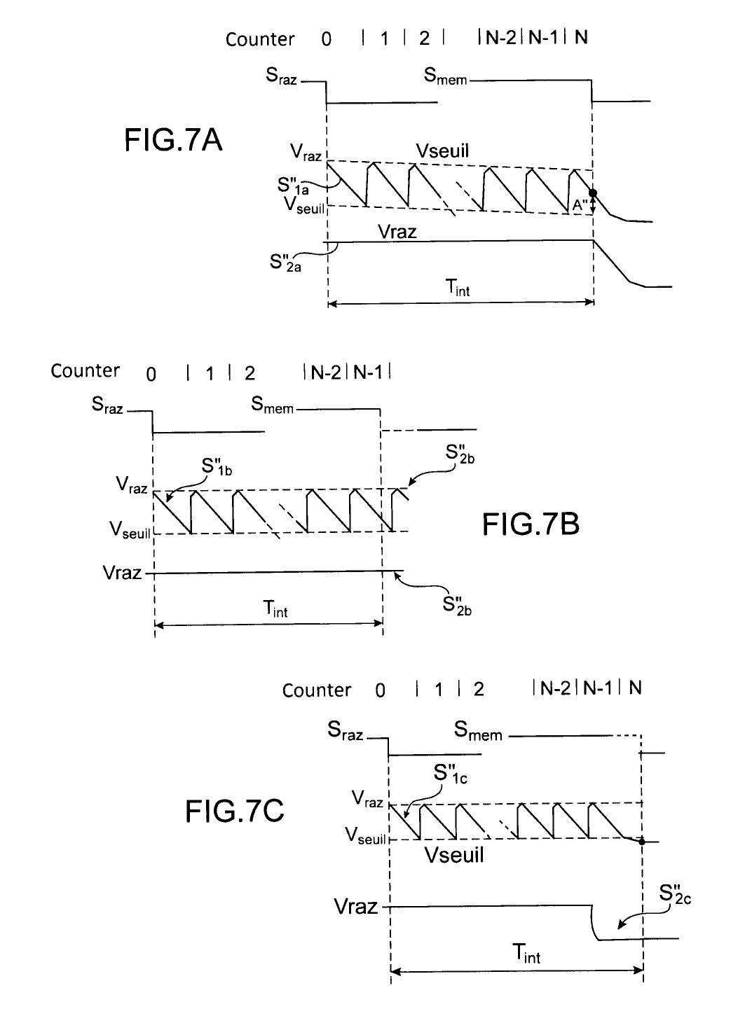

A first limit case, representative of under-lighting of the detector relative to the detection range of the bolometer or a scene variation too weak to be able to be detected by the bolometer, or under-polarization of the detector, is provided in FIG. 7B. In the first case, when the integration time Tint has elapsed, the counting means 340 have not reached the counting value N, which keeps the output of the switching means 361 at potential Vraz (curve of signal S″2b remaining at Vraz in FIG. 7B).

A second case, of over-lighting relative to the detection range of the bolometer or an over-polarization of the detector, is given in FIG. 7C. In this case, when the integration time Tint has elapsed, the counter 345 has reached the counting value N, which has blocked the retroaction. The switch 351 of the reinitialization means is then open, and the integration capacitor 312 continues its charge and stays charged when its charge is finished. The output of the control means 320 is at the output potential of the integrator 310.

An operating case of the detector, when it is normally lit, is given relative to FIG. 7A.

The start of the integration is triggered by a change of state of the reinitialization signal Sraz.

Then, a deduction or counting of the pulses from the first signal S₁ is done. Each pulse is followed by a retroaction equating to an opposite variation of the first signal.

The repeated retroaction is stopped once the counting means 340 have reached the counting value N, which is done by keeping the switching means 351 of the reinitialization means 350 open.

When the counting means 340 have reached the counting value N, the switching means 361 switches and are connected to the output of the integrator 310. The integration capacitor 312 then continues its charge.

The monostable 333 can be associated with locking means for the counting of the pulses when a number of pulses N has been counted.

When the integration time Tint has elapsed, the storage signal Smem changes states, so that a sampling at the output of the control means is done. The amplitude of the second signal S₂, which depends on that of the first signal S₁, is then stored for example via a capacitor 372.

Multiplexing means 380 can be provided at the output of the sampling means.

1-15. (canceled)

16: A microelectronic device for electromagnetic radiation measurement comprising:
at least one electromagnetic radiation detector, or a bolometer, configured to deliver a current based on intensity of detected radiation;
an integrator including an integration capacitor configured to output, during an integration time between a beginning-of-integration moment and an end-of-integration moment, a first signal with variable amplitude and frequency according to current emitted by the detector, in a form of a series of pulses; and
a controlling device to control the first signal, to deliver a second signal and comprising: a counter configured to count or deduct each pulse of the first signal detected during the integration time and to indicate an end of counting when a predetermined number N of pulses is reached, the controlling device further, when the end-of-integration time is reached and a predetermined number N of pulses has been counted or deducted by the counter, to emit a second amplitude signal, depending on or equal to the amplitude of the first signal.

17: The microelectronic device according to claim 16, further comprising:
a sampler, configured to store the second signal, when the predetermination integration duration has elapsed.

18: The microelectronic device according to claim 16, the controlling device further comprising:
a pulse detector to detect the pulses from the first signal.

19: The microelectronic device according to claim 16, the controlling device further configured, when the end-of-integration time is reached and a number smaller than N pulses has been counted or deducted by the counter, to deliver a second signal with an amplitude equal to a first threshold potential.

20: The microelectronic device according to claim 16, the controlling device further configured, when the end-of-integration time is reached and the number N of pulses has been counted or deducted by the counter, to deliver a second signal with an equal amplitude, or at a saturation potential reached by the first signal.

21: The microelectronic device according to claim 16, wherein the controlling device further includes: a switching device configured, when an end-of-counting is indicated by the counter, to switch between a first threshold potential, and the output of the integrator.

22: The microelectronic device according to claim 16, wherein the controlling device further includes: a reinitialization device configured, during the integration time, following each pulse detected in the first signal and as long as the number N of detected pulses is not reached, to apply a reinitialization signal, to at least one terminal of the integration capacitor so as to vary the first signal in a manner opposite the detected pulse.

23: The microelectronic device according to claim 22, the reinitialization device being configured to stop application of the reinitialization signal when the number N of detected pulses is reached.

24: The microelectronic device according to claim 22, the reinitialization device comprising at least one switch, the switch being controlled by at least one signal indicating beginning of counting provided for reinitializing counting done by the counter, and at least one signal indicating the end of counting generated by the counter when the predetermined number N of pulses is reached.

25: The microelectronic device according to claim 22, the reinitialization device comprising at least one first pair of switches, and at least one second pair of switches, the first pair of switches and the second pair of switches being controlled by the counting device.

26: The microelectronic device according to claim 25, wherein the integration capacitor is connected to an amplifier, the first pair of switches configured to connect a first terminal of the capacitor alternatively to the output and the inverting input of the amplifier, the second pair of switches configured to connect a second terminal of the capacitor alternatively to the inverting input and the output of the amplifier.

27: A matrix sensor comprising a microelectronic device according to claim 16, the detector belonging to a matrix of detectors.

28: The matrix sensor comprising:
a plurality of elementary cells, at least some of the cells including a microelectronic device according to claim 16.

29: The matrix sensor according to claim 28, wherein the integration capacitor is formed by a transistor.

30: The microelectronic device according to claim 16, the detector including at least one bolometer.
